(19) United States
(12) Patent Application Publication
(10) Pub. No.: US 2024/0300854 A1
(43) Pub. Date: Sep. 12, 2024

(54) MATERIAL COMPRISING A STACK OF THIN LAYERS FOR THERMAL INSULATION AND AESTHETIC PROPERTIES

(71) Applicant: SAINT-GOBAIN GLASS FRANCE, COURBEVOIE (FR)

(72) Inventors: Priyesh DHANDHARIA, PERUNGUDI, CHENNAI (IN); Soumyadeep MISRA, THIRUVANMIYUR, CHENNAI (IN); Veronique RONDEAU, ASNIÈRES SUR SEINE (FR)

(21) Appl. No.: 18/258,470

(22) PCT Filed: Dec. 17, 2021
(86) PCT No.: PCT/IN2021/051183

§ 371 Date: Jun. 20, 2023

(30) Foreign Application Priority Data
Dec. 21, 2020 (IN) 202041055494

(51) Int. Cl. C03C 17/36; C03C 23/00

(52) U.S. Cl. CPC C03C 17/3613; C03C 17/3626; C03C 17/3644; C03C 17/366; C03C 23/007; C03C 2203/52; C03C 2217/228; C03C 2217/256; C03C 2217/281

(57) ABSTRACT

A material includes a transparent substrate deposited with a stack of thin layers on at least one of its surface for thermal insulation and aesthetic properties is disclosed. The stack of thin layers successively includes, starting from the substrate not more than two metallic functional layers based on silver F1, F2 and three dielectric coatings M1, M2, M3 including at least one dielectric layer such that each of the metallic functional layer is sandwiched between two dielectric coatings. The material including the stack of thin layers exhibits blue color in external reflection (Rₑₓₜ) and has less than 20% reflection internally and externally. Additionally, the material has a high selectivity while retaining a light transmission in the visible spectrum as less as 40%, and not higher than 50%.

### TECHNICAL FIELD

The present disclosure relates, in general to a material comprising a transparent substrate, on the surface of which a stack of thin layers is deposited which comprises a plurality of functional layers making it possible to act on the solar and/or infrared radiation likely to strike said surface. More specifically the invention relates to a material having a high thermal performance, selectivity and improved aesthetics with a blue external reflection color and less than 20% reflection internally and externally.

### BACKGROUND

Solar control glass has a large part to play in the future of construction, as external temperatures will continue to rise and so will the expectations of comfort. Legal agreements and devices aimed at reducing the environmental impacts of human activities are increasing on regional, national and international scales. These agreements and arrangements aim in particular to reduce the energy consumption of infrastructure. They recommend or oblige in particular the equipment of buildings and transport vehicles so as to reduce the energy consumption of their air conditioning and heating means.

The glazed surfaces often constitute the majority of the external surfaces of buildings and transport vehicles. Their share is constantly growing to meet the needs of users in terms of lighting with natural light. However, these glass surfaces can be passive sources of heat, especially during periods of strong sunshine in hot and humid climatic conditions. Consequently, the temperature variations inside buildings and vehicles fitted with these glass surfaces are significant. These temperature variations can cause feelings of discomfort and encourage use of significant means of air conditioning.

For these reasons of energy saving and comfort, the glass surfaces must be functionalized in order to act on incident solar and/or infrared radiation and to reduce “greenhouse effect” phenomena. The functionalization of these surfaces is generally carried out by depositing on said surfaces a stack of layers comprising metallic functional layers. These layers confer on the surfaces, as well as on the glazing units which comprise them, so-called “selective” functions making it possible to reduce the amount of energy transmitted through the glazing towards the interior without prejudice to the light transmission in the visible spectrum.

Depending on the climates of the countries where these glazings are installed, the desired performance in terms of light transmission and solar factor may vary within a certain range. The light transmission must be low enough to eliminate glare and high enough so that the reduction in the amount of light penetrating inside the space delimited by said glazing does not make it necessary to use artificial light. For example, in countries with high levels of sunshine, there is a great demand for glazings having a light transmission of the order of 50% and sufficiently low solar factor values.

Glazings comprising transparent substrates coated with a stack of thin layers comprising two functional metallic layers, each positioned between two dielectric coatings, have been proposed in order to improve the solar protection while retaining a sufficient light transmission. These stacks are generally obtained by a series of depositions carried out by sputtering, optionally magnetron sputtering. These glazings are described as selective since they make it possible:
to reduce the amount of solar energy penetrating inside buildings by having a low solar factor (SF or g),
to guarantee a sufficient light transmission (TL),
to have low emissivity to ensure better insulation from the surrounding.

According to the present disclosure: solar factor “g” is understood to mean the ratio, as a percentage, of the total energy (including directly transmitted energy and the re-radiated energy) entering the space through the glazing to the incident solar energy and selectivity “s” is understood to mean the ratio of the light transmission to the solar factor TL/g.

The higher the selectivity, s, of a functionalized glazed surface or of a glazing which comprises a functionalized glazed surface, the higher the amount of visible light transmission with optimal thermal performance, ideally without prejudice to the light transmission in the visible spectrum. According to the definition above, a high selectivity can be obtained by increasing the light transmission, TL, and/or by decreasing the solar factor, g.

The light transmission and the solar factor depend in particular on the thicknesses of the metallic functional layers that comprise the layer stack deposited on the surface of the transparent substrate which forms the glass surface. The light transmission and the solar factor vary contradictorily with the thicknesses of the functional layers. The thinner the functional layers, the higher is the light transmission and solar factor. While high light transmission ensures high level of natural light inside the building, the solar factor also remains high because of increased level of heat coming inside the building. This minimizes the energy efficiency of the building.

Thus as a customer the choice between increased natural lighting or performance (increased energy efficiency) is a difficult one to make. While there are products in the market that provide glazings with:
high light transmission, at least 50%, even 60%; and
high solar factor, g, almost 40%, which provide aesthetic performance but not energy efficiency, there are no available products for customers wanting to have glazing with improved energy performance without compromising on its aesthetic quotient.

Thus the objective here is to obtain a functionalized glazing with functions such as:
light transmission of as less as 40%, and not higher than 50%;
solar factor, g, as low as 35% or even lesser than 25%

The glazed surfaces can further have an aesthetic function in terms of reflection color for buildings and transport vehicles in which they are likely to be incorporated. In certain applications, they must present, in external reflection, a colored surface appearance. The shades of color should ideally vary little depending on the angle of observation. A distinctive blue color external reflection is obtained when the values of the two parameters a*, b* are negative, ideally between 0 and −5, −10 and −20, respectively.

The external reflection depends partly on the thickness of the metallic functional layers. The thicker the metallic functional layers, the higher the external reflection, and vice versa. However, it has been found that any increase in the thickness of the functional layers causes a decrease in light transmission and solar factor. Therefore, although according to the objective of the present invention, a thicker functional layer is desired for obtaining low light transmission and solar factor, the increased reflection is undesirous for visual comfort.

It should further be noted that higher the reflection (be it internal and/or external) lower will be the visual comfort of building occupants and bystanders, respectively. Therefore, it is desirable and beneficial to keep the internal and/or external reflections lower.

In brief, thicker functional layers are preferred for lesser light transmission TL & low solar factor g, the combination of which facilitates a high selectivity. While also optimizing the thickness of functional layers to facilitate decreased external and internal reflection. However, the materials currently on the market do not make it possible to combine a low solar factor, low light transmission, a high selectivity (>1.5, more preferably >1.7) and also a low reflection on the internal and external side while achieving a distinctive blue external reflection color.

Thus the objective of the invention is therefore to develop a material having:
exceptional solar control properties and in particular high selectivity for a reduced light transmission in the order of 40%, that would reduce the load on the air-conditioning system of the building; and
exceptional aesthetic characteristics, in particular a low reflective external blue color and a low internal reflection.

According to the invention, it is therefore sought to minimize solar factor; increase selectivity; enhance aesthetics while keeping a lower light transmission suitable for allowing increased energy efficiency.

The complexity of the stacks comprising two silver-based functional layers makes it difficult to improve the thermal performance and reflection properties without adversely affecting the other properties of the stack. The Applicant has surprisingly discovered that by optimizing the thicknesses of the two metallic functional layers and the thicknesses of the dielectric coatings, a layer stack capable of exhibiting the desired properties is obtained. The solution of the invention represents an excellent compromise between the optical performance, thermal performance, transparency and aesthetic appearance.

Following listed documents, see PCT Publication No. WO2020/083691, WO2019/098980; Chinese utility model CN207468492, CN 202449998, CN208517286; U.S. Pat. No. 7,736,746 and Chinese patent No. 209242941, 106186723 are herein incorporated as references that are well known to the Applicant. Unfortunately, none of these references achieve all the optical, performance and aesthetic characteristics desired according to the present disclosure. In view of the above, it will be appreciated that there exists a need in the art to develop a material having exceptional solar control properties, minimized light transmission values, minimized solar factor and increased selectivity, all while retaining the desired aesthetics and increased energy efficiency.

It is thus a purpose of this disclosure to help achieve all the said characteristics, detail of which will become apparent to the skilled artisan once given the following disclosure.

Certain example embodiments of this disclosure relate to glazing that is durable having an increased thermal stability and mechanical performance while retaining desired optical characteristics of the article. Certain example embodiments of this invention also relate to a process of making the same.

### SUMMARY OF THE DISCLOSURE

In one aspect of the present disclosure, a material comprising a transparent substrate deposited with a stack of thin layers on at least one of its surface successively comprising, starting from the substrate, not more than two metallic functional layers based on silver F1, F2 and three dielectric coatings M1, M2, M3 comprising at least one dielectric layers such that each of the metallic functional layer is sandwiched between two dielectric coatings is disclosed. The material characterized in that the thickness of second functional layer F2 is greater than the thickness of first functional layer F1; wherein
the ratio of the thickness of second functional layer F2 to the thickness of the first functional layer F1 is greater than 1.1 but is less than 1.5, inclusive of the said value;
the dielectric coatings M1, M2 and M3 each have a thickness T1, T2 and T3, respectively satisfying the following equation: T1, T3<T2; wherein,
thickness T1 of the dielectric coating M1 is greater than 20 nm and less than 40 nm, inclusive of the said values;
thickness T2 of the dielectric coating M2 is greater than 60 nm and less than 110 nm, inclusive of the said values;
thickness T3 of the dielectric coating M3 is greater than 15 nm and less than 55 nm, inclusive of the said values, wherein the material is blue in external reflection (Rₑₓₜ) and has less than 20% reflection internally and externally.

The present disclosure also relates to: the process for obtaining a material according to the disclosure, the glazing comprising at least one material according to the invention, the use of a glazing according to the invention as solar-control glazing for buildings or vehicles, a building or vehicle comprising a glazing according to the disclosure.

Other features and aspects of this disclosure will be apparent from the following description and the accompanying drawings.

### BRIEF DESCRIPTION OF THE DRAWINGS

Embodiments are illustrated by way of example and are not limited to those shown in the accompanying figures.

FIG. 1 illustrates a stack of thin layers deposited on a transparent glass substrate, according to one embodiment of the present disclosure; and

FIG. 2 illustrates a stack of thin layers deposited on a transparent glass substrate, according to one other embodiment of the present disclosure.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

Wherever possible, the same reference numbers will be used throughout the drawings to refer to the same or similar parts. Embodiments disclosed herein are related to material having a high thermal performance, selectivity and improved aesthetics with a neutral internal reflection and a blue external reflection colors.

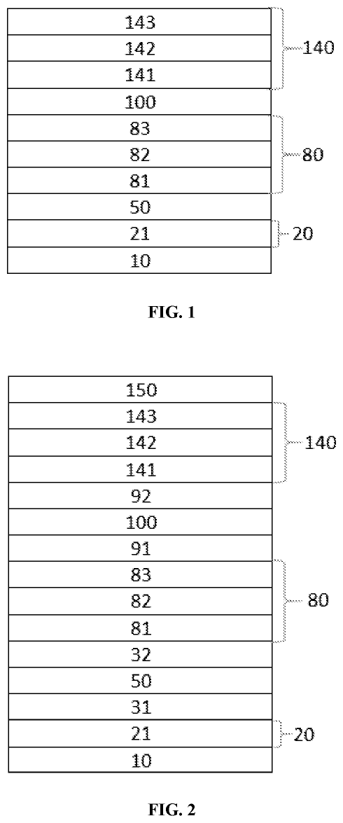

FIG. 1 illustrates a structure of a stack of thin layers having two functional metallic layers 50, 100 deposited on a transparent substrate 10. Each of the metallic functional layers 50, 100 is positioned between dielectric coatings 20 (M1), 80 (M2), 140 (M3) such that: the first functional layer 50, starting from the substrate, is positioned between the dielectric coatings 20, 80 and the second functional layer 100 is positioned between the dielectric coatings 80, 140. The dielectric coatings 20, 80, 140 each comprise at least one dielectric layer. The dielectric coating 20 comprises at least one dielectric layer 21. The dielectric coating 80 comprises at least three dielectric layers 81, 82, 83. The dielectric coating 140 comprises at least three dielectric layers 141, 142, 143. The stack of thin layers does not include any oxide based layers between the transparent substrate and the first functional layer F1.

The stack of thin layers may further comprise barrier layers 31, 91 (not represented) deposited as under layers in contact with the functional layers 50 or 100, respectively; barrier layers 32, 92 (not represented) deposited as over layers in contact with the functional layers 50 or 100, respectively and at least one protective layer 150 (not represented).

By adjusting the thicknesses of the functional layers 50, 100 and the dielectric coatings 20, 80, 140, the transparency of the glazing may be controlled so as to obtain light transmission TL values as low as 40%, which range is very particularly suitable for glazings intended to be used in tropical countries. But the major advantage of the invention is achieving such low light transmission alongside a distinctive blue external reflection color with sufficiently low internal and external reflection values that do not detriment the solar protection performance of the glazing. The excellent energy performance is also maintained with substantial modifications of the other parameters of the stack such as the nature, the thickness and the sequence of the layers forming it.

Within the meaning of the present invention, the label “first”, “second”, “third” for the functional layers and/or dielectric coatings are defined starting from the substrate bearing the stack and with reference to the layers or coatings having the same function. For example, the functional layer closest to the substrate is the first functional layer, the next one moving away from the substrate is the second functional layer. Likewise, the dielectric coating closest to the substrate is the first dielectric coating, the next one moving away from the substrate is the second dielectric coating etc. Thicknesses stated in the present document with no other specifications are physical, real or geometric thicknesses referred to as T and are expressed in nanometers (and not optical thicknesses). The thickness of the dielectric coatings is represented as T. T1, T2 and T3 according to the specific dielectric coating they refer to.

According to one embodiment of the present invention, the two functional metallic layers 50, 100 satisfy the condition: the thickness of second functional layer F2 is greater than the thickness of first functional layer F1, specifically described as the ratio of the thickness of second functional layer F2 to the thickness of the first functional layer F1 is greater than 1.1 but is less than 1.5, inclusive of the said value. The thickness F1 of the first functional layer 50 preferably ranges between 8 nm and 11 nm. The thickness of the second functional layer 100 preferably ranges between 9 nm and 13 nm. These thickness ranges for the functional metallic layers 50, 100 are the ranges for which the best results are obtained for a light transmission as low as 40%, blue external reflection (Rₑₓₜ), less than 20% reflection internally and externally, a high selectivity and low solar factor.

According to another embodiment of the present invention, the stack of thin layers further comprises barrier layer 31, 91 deposited as under layers in contact with the functional layer 50 and barrier layers 32, 92 deposited as over layers in contact with the functional layer 100, as illustrated in FIG. 2. In an alternate embodiment the stack of thin layers comprise more than one barrier layers deposited as under layers in contact with the functional layer; and/or more than one barrier layers deposited as over layers in contact with the functional layer.

The role of the barrier layers deposited over the functional layers is conventionally to protect the layers underneath from a possible degradation during the deposition of the upper dielectric coating and during an optional high-temperature heat treatment of the annealing, bending and/or tempering type.

Whereas, the role of barrier layer below the functional layer is to promote adhesion and improve the mechanical durability during transport and processing. The barrier layers are selected from metallic layers based on a metal or on a metal alloy, metal nitride layers and metal oxide layers of one or more elements selected from NiCr or NiCrOₓ, NiCrNₓ. When these barrier layers are deposited in metallic, nitride or oxide form, these layers may undergo a partial or complete oxidation depending on their thickness and the nature of the layers that surround them, for example, at the time of the deposition of the next layer or by oxidation in contact with the underlying layer.

According to one embodiment of the present invention, the barrier layers 31, 91, 32, 92 satisfy the condition: each functional metallic layer is in contact with at least one barrier layer selected from a barrier under layer and a barrier over layer, and/or each functional metallic layer is in contact with a barrier under layer and a barrier over layer, and/or the thickness of each barrier layer ranges between 0.1 nm and 5 nm.

According to another embodiment, the dielectric coatings 20, 80, 140 satisfy the condition: the dielectric coatings 20, 80 and 140 each have a thickness T1, T2 and T3, respectively satisfying the following equation: T1, T3<T2, and/or thickness T1 of the dielectric coating 20 (M1) is greater than 20 nm and less than 40 nm, and/or thickness T2 of the dielectric coating 80 (M2) is greater than 60 nm and less than 110 nm and/or thickness 140 (T3) of the dielectric coating M3 is greater than 15 nm and less than 55 nm, inclusive of all said values mentioned for T1, T2 and T3; three dielectric coatings 20, 80, 140 comprise at least one dielectric layers based on a material selected from silicon nitride, titanium nitride, aluminum nitride or oxynitrides of silicon and aluminum, zinc oxide, tin and zinc oxide, silicon and zirconium nitride, tin oxide, titanium oxide, silicon oxide, titanium and tin oxide, alone or in combination; dielectric coatings 80, 140 each comprise at least three dielectric layers 81, 82, 83; 141, 142, 143 correspondingly; dielectric coating 20 comprises only one dielectric layer 21.

According to preferred embodiments of the present invention, the dielectric coating 20 comprising the dielectric layer 21 is positioned below the first functional metallic layer 50; the dielectric layer 21 has a barrier function and is based on oxides such as SiO₂ and Al₂O₃, silicon nitrides Si₃N₄ and AlN and oxynitrides SiOₓN_{y} and AlOₓN_{y}, most preferably silicon aluminum nitride sputtered from a Si:Al target. According to one aspect of the preferred embodiment, the thickness of the dielectric layer 21 ranges between 20 nm and 40 nm.

According to preferred embodiments of the present invention, the dielectric coating 140 comprising the dielectric layers 141, 142, 143 are positioned above the second functional metallic layer 100; the dielectric layer 141 has a stabilizing function and is based on an oxide selected from zinc oxide, tin oxide or a mixture of at least two thereof, most preferable based on crystalline oxide in particular based on zinc oxide; the dielectric layer 142 has a smoothening function based on a mixed nitride of at least two metals selected from Si, Zr, Zn, Sn, preferably silicon zirconium mixed nitride layers which are optionally doped; the dielectric layer 143 has a barrier function and is based on oxides such as SiO₂ and Al₂O₃, silicon nitrides Si₃N₄ and AlN and oxynitrides SiOₓN_{y} and AlOₓN_{y}, most preferably silicon aluminum nitride sputtered from a Si:Al target. According to one aspect of the preferred embodiment, the thickness of the dielectric layer 141 ranges between 2 nm and 10 nm; the thickness of the dielectric layer 142 ranges between 1 nm and 20 nm; and the thickness of the dielectric layer 143 ranges between 5 nm and 35 nm.

The dielectric layer 142 having a smoothing function is generally sandwiched between at least one dielectric layer having a barrier function and at least one dielectric layer having a stabilizing function, preferably with the at least one dielectric layer having a stabilizing function positioned below the dielectric layer having a smoothing function and the at least one dielectric layer having a barrier function positioned above the dielectric layer having a smoothing function. In a particular exemplary embodiment, the dielectric layer 142 is a silicon zirconium mixed nitride layer.

It is important to note that zirconium mixed silicon nitride (SiZrN) has slightly higher refractive index compared to Si₃N₄ (which is typically used for smoothening function). Zr is a stable material and does not cause any degradation of the dielectric layer. However, one can replace this layer with Si₃N₄ in which case owing to the lesser refractive index of Si₃N₄ the applied thickness of Si₃N₄ layer may be slightly higher than that required for a SiZrN layer.

According to preferred embodiments of the present invention, the dielectric coating 80 comprises dielectric layers 81, 82, 83, all dielectric layers are positioned below the second metallic functional layer 100. The dielectric coating 80 comprises at least one dielectric layer having a barrier function; and/or at least one dielectric layer having a stabilizing function; and/or at least one dielectric layer having a smoothing function. According to this embodiment, the dielectric layer 81 is a dielectric layer having a barrier function and is based on oxides such as SiO2 and Al2O3, silicon nitrides Si3N4 and AlN and oxynitrides SiOxNy and AlOxNy, most preferably silicon aluminum nitride sputtered from a Si:Al target. According to this embodiment, the dielectric layer 82 is a dielectric layer having a smoothing function based on a mixed nitride of at least two metals selected from Si, Zr, Zn, Sn, preferably silicon zirconium mixed nitride layers which are optionally doped. According to this embodiment, the dielectric layer 83 having a stabilizing function and is based on an oxide selected from zinc oxide, tin oxide or a mixture of at least two thereof, most preferable based on a mixed oxide of at least two metals selected from Sn, Zn, In, Ga, preferably zinc tin mixed oxide layers which are optionally doped.

The dielectric layer 82 having a smoothing function, is generally sandwiched between at least one dielectric layer having a barrier function and at least one dielectric layer having a stabilizing function, preferably with the at least one dielectric layer having a barrier function positioned below the dielectric layer having a smoothing function and the at least one dielectric layer having a stabilizing function positioned above the dielectric layer having a smoothing function.

According to one aspect of the preferred embodiment, the thickness of the dielectric layer 81 ranges between 30 nm and 65 nm; the thickness of the dielectric layer 82 ranges between 20 nm and 45 nm; the thickness of the dielectric layer 83 ranges between 2 nm and 10 nm. According to yet another aspect of the embodiment, the thickness ratio of the dielectric layer 81 to that of the dielectric layer 82 is greater than 1. This thickness ratio provides for improved color stability post heat treatment.

Dielectric layer having a barrier function according to the present invention should be understood as a layer made of a material capable of forming a barrier to the diffusion of sodium, oxygen and/or water at high temperature, originating from either the transparent substrate or the ambient atmosphere towards the functional layer. The constituent materials of the dielectric layer having a barrier function thus must not undergo chemical or structural modification at high temperature which would result in a modification to their optical properties. The layer or layers having a barrier function are preferably also selected from a material capable of forming a barrier to the constituent material of the functional layer. The dielectric layers having a barrier function thus allow the stack to be subjected to heat treatments of the annealing, tempering or bending type, without significant optical change.

Dielectric layer having a stabilizing function according to the present invention should be understood as a layer selected so as to stabilize the interface between the functional layer and this layer. This stabilization results in the reinforcing of the adhesion of the functional layer to the layers which surround it and thus it will oppose the migration of its constituent material. The dielectric layer(s) having a stabilizing function may be directly in contact with a functional layer or separated by a blocking layer.

Preferably, the final dielectric layer of each dielectric coating located underneath the second functional layer F2 is a dielectric layer having a stabilizing function. This is because it is advantageous to have a layer having a stabilizing function, for example, based on zinc oxide underneath a functional layer, as it facilitates the adhesion and the crystallization of the silver-based functional layer and increases its quality and its stability at high temperature.

It is also advantageous to have a layer having a stabilizing function, for example, based on zinc oxide on top of a functional layer, in order to increase the adhesion thereof and to optimally oppose the diffusion from the side of the stack opposite the substrate. The dielectric layer(s) having a stabilizing function may thus be on top of and/or underneath at the second functional layer F2, either directly in contact therewith or separated by a blocking layer.

Advantageously, each dielectric layer having a barrier function is separated from the second functional layer F2 by at least one dielectric layer having a stabilizing function.

Dielectric layer having a smoothing function according to the present invention should be understood as a layer having the role of promoting the growth of the stabilizing layer in a preferential crystallographic orientation, which promotes the crystallization of the silver layer via epitaxial phenomena. The smoothing layer is located underneath or overhead and preferably in contact with a stabilizing layer. The smoothing layer based on a mixed oxide or nitride may be described as “noncrystalline” in the sense that it may be completely amorphous or partially amorphous and thus partially crystalline, but it cannot be completely crystalline over its entire thickness. It cannot be of metallic nature since it is based on a mixed oxide (a mixed oxide is an oxide of at least two elements) or a mixed nitride (a mixed nitride is a nitride of at least two elements).

According to an optional embodiment of the present invention, the stack of thin layers comprises at least one protective layer 150 deposited farthest from the surface capable of being in contact with the atmosphere based on titanium zirconium nitride or oxynitride, titanium zirconium oxide, titanium oxide or carbon, alone or in combination. According to another optional embodiment of the present invention, the stack of thin layers comprises at least two protective layers disposed farthest from the surface capable of being in contact with the atmosphere one layer based on zirconium nitride or oxynitride, titanium zirconium oxide, titanium oxide and another layer based on Carbon. The protective layer generally has a thickness of less than 5 nm, more preferably less than 4 nm.

According to a particular exemplary embodiment of the present invention, the stack of thin layers comprises starting from the glass substrate 10, as illustrated in FIG. 2:
a first dielectric coating 20 comprising at least one dielectric layer 21 having a barrier function;
optionally a barrier layer 31;
a first functional layer 50;
optionally a barrier layer 32;
a second dielectric coating 80 comprising at least one lower dielectric layer 81 having a barrier function, one dielectric layer 82 having a smoothing function and an upper dielectric layer 83 having a stabilizing function;
optionally a barrier layer 91;
a second functional layer 100;
optionally a barrier layer 92;
a third dielectric coating 140 comprising at least one lower dielectric layer 141 having a stabilizing function, one dielectric layer 142 having a smoothing function, and one upper dielectric layer 143 having a barrier function; and
optionally one protective layer 150.

According to this embodiment, the dielectric coatings 80 and 140 comprise at least one layer of oxide disposed above and in contact and/or below and in contact with the barrier layer, the thickness of said layer of oxide is between 2 nm and 10 nm.

The transparent substrates according to the present invention are preferably made of an inorganic rigid material, such as glass, or an organic material based on polymers (or made of polymer). The substrate is preferably a sheet of glass or of glass-ceramic. The substrate is preferably transparent, colorless (it is then a clear or extra-clear glass) or colored, for example colored blue, grey, green or bronze. The glass is preferably of soda-lime-silica type, but it may also be made of glass of borosilicate or alumino-borosilicate type.

The substrate advantageously has at least one dimension greater than or equal to 1 m, or even 2 m and even 3 m. The thickness of the substrate generally varies between 0.5 mm and 19 mm, preferably between 0.7 and 15 mm, in particular between 2 and 12 mm, or even between 4 and 12 mm. The substrate may be flat or curved, or even flexible.

According to a particular exemplary embodiment of the present invention, the stack of thin layers comprises starting from the glass substrate 10:
a first dielectric coating comprising at least one dielectric layer having a barrier function with thickness ranging between 20 nm and 40 nm;
a barrier layer having a thickness ranging between 0.1 nm and 5 nm;
a first functional layer having a thickness ranging between 8 nm and 11 nm;
a barrier layer having a thickness ranging between 0.1 nm and 5 nm;
a second dielectric coating comprising at least one lower dielectric layer having a barrier function, one dielectric layer having a smoothing function and an upper dielectric layer having a stabilizing function, the overall thickness of the second dielectric coating ranging between 60 nm and 110 nm;
a barrier layer having a thickness ranging between 0.1 nm and 5 nm;
a second functional layer having a thickness ranging between 9 nm and 13 nm;
barrier layer having a thickness ranging between 0.1 nm and 5 nm;
a third dielectric coating comprising at least one lower dielectric layer having a stabilizing function, one dielectric layer having a smoothing function, and one upper dielectric layer having a barrier function, the overall thickness of the third dielectric coating ranging between 15 nm and 55 nm; and
optionally one protective layer having a thickness ranging not greater than 5 nm.

The material, that is to say the substrate coated with the stack, may undergo a high-temperature heat treatment such as an annealing, for example a flash annealing such as a laser or flame annealing, a tempering and/or a bending. The temperature of the heat treatment is greater than 500° C., preferably greater than 550° C., and better still greater than 600° C. The substrate coated with the stack may therefore be curved and/or tempered.

The invention also relates to a glazing comprising a material according to the invention. Conventionally, the faces of a glazing are denoted starting from the outside of the building and by numbering the faces of the substrates from the outside towards the inside of the passenger compartment or room that it equips. This means that the incident solar light passes through the faces in the increasing order of their number.

The stack is preferably positioned in the glazing so that the incident light coming from outside passes through the first dielectric coating before passing through the first functional metallic layer. The stack is not deposited on the face of the substrate that defines the external wall of the glazing but on the inner face of this substrate. The stack is therefore advantageously positioned on face 2, face 1 of the glazing being the outermost face of the glazing, as is customary.

The material may be intended for applications that require the substrate coated with the stack to have undergone a heat treatment at a high temperature such as a tempering, an annealing or a bending. The glazing of the invention may be in the form of monolithic, laminated or multiple glazing, in particular double glazing or triple glazing.

In the case of a multiple glazing, the stack is preferably deposited on face 2, that is to say that it is on the substrate that defines the external wall of the glazing and more specifically on the inner face of this substrate. A monolithic glazing comprises 2 faces; face 1 is on the outside of the building and therefore constitutes the external wall of the glazing, face 2 is on the inside of the building and therefore constitutes the internal wall of the glazing.

A multiple glazing comprises at least two substrates kept at a distance so as to delimit a cavity filled by an insulating gas (e.g., dry air, Ar, Kr or their mixture). The materials according to the invention are very particularly suitable when they are used in double glazings with enhanced thermal insulation (ETI). A double glazing comprises 4 faces; face 1 is outside of the building and therefore constitutes the external wall of the glazing, face 4 is inside the building and therefore constitutes the internal wall of the glazing, faces 2 and 3 being on the inside of the double glazing.

In the same way, a triple glazing comprises 6 faces; face 1 is outside of the building (external wall of the glazing), face 6 is inside the building (internal wall of the glazing) and faces 2 to 5 are on the inside of the triple glazing. A laminated glazing comprises at least one structure of first substrate/sheet(s)/second substrate type. The stack of thin layers is positioned on at least one of the faces of one of the substrates. The stack may be on the face of the second substrate not in contact with the, preferably polymer, sheet. This embodiment is advantageous when the laminated glazing is assembled as double glazing with a third substrate.

The glazing according to the invention, used in a multiple glazing e.g., a double glazing unit, has low and pleasant internal reflection. Likewise, the glazing has a blue color in external reflection. The external color is not too dull at the same time is not too reflective. These two features aid in visual comfort for people facing the interior and exterior of the glazing. Furthermore, these visual appearance remains virtually unchanged irrespective of the angle of incidence with which the glazing is observed (normal incidence and under an angle). This means that an observer does not have the impression of a significant lack of uniformity in color or in appearance.

The glazing of the invention has colors in transmission in the L*a*b* color measurement system:
a*T greater than −12, preferably between −7 and −11; in a particular exemplary embodiment a*T is −9;
b*T less than 0, preferably between −2 and −6; in a particular exemplary embodiment b*T is −4.

The glazing of the invention has colors in reflection on the external side in the L*a*b* color measurement system:
a*ext less than 1, preferably between −1 and −5; in a particular exemplary embodiment a* ext is −3;
b* ext less than −10, preferably less than −12; in a particular exemplary embodiment b* ext is −14.5.

According to advantageous embodiments, the glazing of the invention in the form of a double glazing comprising the stack positioned on face 2 makes it possible to achieve, in particular, the following performances:
a solar factor less than or equal to 35%, preferably less than or equal to 25%, and/or a high selectivity, in order of increasing preference, of at least 1.5, of at least 1.7, and/or
a low emissivity, in particular of less than 10%, and/or
a light reflection on the external side of less than or equal to 20%, preferably less than or equal to 18%, and/or
a light reflection on the internal side of less than or equal to 20%, preferably less than or equal to 15%, and/or
blue in external reflection.

Preferably, the stack is deposited by magnetron sputtering. According to this advantageous embodiment, all the layers of the stack are deposited by magnetron sputtering.

The invention also relates to the process for obtaining a material according to the invention, wherein the layers of the stack are deposited by magnetron sputtering.

### EXAMPLES

### Example 1

### Preparation of the Substrates: Stack of Thin Layers and Heat Treatments

Stack of thin layers, defined below, are deposited on substrates made of clear soda-lime glass with a thickness of 6 mm.

In the example of the invention:
the functional layers are layers of silver (Ag),
the barrier layers are metallic layers made of nickel-chromium alloy (NiCr),
the dielectric barrier layers are based on silicon nitride, doped with aluminum (Si₃N₄:Al),
the dielectric stabilizing layers are made of zinc oxide (ZnO),
the dielectric smoothing layer above the function layer F1 is based on zinc tin mixed oxide (SnZnOx),
the dielectric smoothing layer above the function layer F2 is based on silicon zirconium nitride (SiZrN),
the protective layer is made of titanium zirconium nitride (TiZrNx).

Table 1 lists the materials and thicknesses in nanometers for each layer or coating that forms the stacks as a function of their position with respect to the substrate bearing the stack (final line at the bottom of the table). The “Ref.” numbers correspond to the references from FIG. 2.

TABLE 1
Stack of thin layers

| | | | | | Comparative | Comparative |
|---|---|---|---|---|---|---|
| | | Sample 1 | Sample 2 | Sample 3 | sample 1 | sample 2 |
| | Ref | Thickness | Thickness | Thickness | Thickness | Thickness |
| Element | No. | (nm) | (nm) | (nm) | (nm) | (nm) |
| TiZrN | 150 | 1.2 | 1.2 | 1.2 | 1.2 | 1.2 |
| Si3N4:Al | 143 | 19.5 | 20.5 | 20.5 | 37 | — |
| SiZrN | 142 | 8 | 8 | 8 | — | 27 |
| ZnO | 141 | 5 | 5 | 5 | 6 | 6 |
| NiCr | 92 | 3 | 3 | 2 | 3 | 3 |
| Ag | 100 | 11.5 | 10.8 | 11.5 | 11.5 | 11.5 |
| NiCr | 91 | 1.5 | 1.5 | 2.5 | 1.5 | 1.5 |
| ZnO | 83 | 6 | 6 | 6 | 6 | 6 |
| SnZnOx | 82 | 35 | 35 | 35 | 35 | 35 |
| Si3N4:Al | 81 | 45 | 49 | 49 | 45 | 45 |
| NiCr | 32 | 1.5 | 2.5 | 2.5 | 1.5 | 1.5 |
| Ag | 50 | 9.5 | 9.2 | 8.7 | 9.5 | 9.5 |
| NiCr | 31 | 2 | 2 | 2 | 2 | 2 |
| Si3N4:Al | 21 | 30 | 45 | 41 | 30 | 30 |
| Glass | 10 | 6 mm | 6 mm | 6 mm | 6 mm | 6 mm |

### Solar Control and Optical Properties

Table 2 lists the main optical characteristics measured when the glazings are part of double glazing having a 6/15/6 structure: 6 mm glass/15 mm interlayer space filled with 90% argon and 10% air/6 mm glass, the stack being positioned on face 2 (face 1 of the glazing being the outermost face of the glazing, as is customary). For these double glazings:
T_{L} indicates: the light transmission in the visible region in %, measured according to the illuminant D65 Obs 2;
a*T and b*T indicate the a* and b* colors in transmission in the L*a*b* system measured according to the illuminant D65 Obs 2 and measured perpendicularly to the glazing;
Rₑₓₜ indicates: the light reflection in the visible region in %, measured according to the illuminant D65 Obs 2 on the side of the outermost face, face 1;
a*Rₑₓₜ and b*Rₑₓₜ indicate the a* and b* colors in reflection in the L*a*b* system measured according to the illuminant D65 Obs 2 on the side of the outermost face and thus measured perpendicularly to the glazing;
Rᵢₙₜ indicates: the light reflection in the visible region in %, measured according to the illuminant D65 Obs 2 on the side of the internal face, face 4;
a*Rᵢₙₜ and b*Rᵢₙₜ indicate the a* and b* colors in reflection in the L*a*b* system measured according to the illuminant D65 Obs 2 on the side of the internal face and thus measured perpendicularly to the glazing.

The colorimetric values at an angle a*g60° and b*g60° are measured on single glazing under an incidence of 60°. This takes into account the stability of the colors at an angle.

TABLE 2
Optical & Solar Control Properties

| | Transmission | | | External reflection | | | | | | Solar | |
|---|---|---|---|---|---|---|---|---|---|---|---|
| | T_{L} | | | Rₑₓₜ | | | Internal reflection | | | Factor | |
| | % | a*T | b*T | % | a*G | b*G | Rᵢₙₜ | a*C | b*C | SF | Selectivity |
| Sample 1 | 40 | −9 | −4 | 16 | −3 | −14.5 | 12 | −3.5 | −9 | 22 | 1.82 |
| Sample 2 | 39.5 | −7 | −6 | 15.2 | −3.7 | −10.3 | 11 | −4.8 | −8 | 23 | 1.72 |
| Sample 3 | 39 | −6.8 | −6 | 15.2 | −2 | −12.1 | 12 | −4 | −7.5 | 22 | 1.77 |
| Com. | 43 | −11 | 0.5 | 15 | −0.5 | −22 | 12 | 0.6 | −16 | 23 | 1.87 |
| sample 1 | | | | | | | | | | | |
| Com. | 42 | −8.5 | −2.5 | 17 | −5.2 | −13 | 14 | −10.4 | −1 | 23 | 1.83 |
| sample 2 | | | | | | | | | | | |

TABLE 3
Calorimetric Values

At SGU Glazing
Glass side color Value

| Samples | a*60 | b*60 |
|---|---|---|
| Sample 1 | 1 | −11 |
| Sample 2 | 0 | −8 |
| Sample 3 | 1.5 | −9 |
| Com. sample 1 | −0.8 | −14 |
| Com. sample 2 | −5.8 | −10.6 |

The samples according to the present invention all have a blue color in external reflection. The solution proposed therefore makes it possible to have a solar factor of less than 25% while keeping a selectivity of greater than 1.5 and favorable aesthetics. The examples presented are particularly advantageous since they have, in addition to low solar factor and a high selectivity, extremely low internal and external reflections, particularly less than 20%.

The comparative samples 1 and 2 were prepared with only 2 dielectric layers in the third dielectric coating, comparative sample 1 with layers ZnO/Si₃N₄:Al and comparative sample 2 with ZnO/SiZrN. In spite of this change the layer thicknesses of the third dielectric coating is optimized to achieve the desired visible light transmission values. However, depending on the layers used above ZnO external a* and b* can vary slightly and thus an optimum ratio is required for desired external aesthetic.

### INDUSTRIAL APPLICABILITY

The glazing described in the present disclosure finds application as a glazed element in building. In this application case, the glazing may form a double or triple glazing with the coating side of the glass arranged facing the closed space inside the multiple glazing. The glazing may also form a laminated glazing whose stack of layers may be in contact with the thermoplastic adhesive material connecting the substrates, in general PVB. The glazing according to the invention is, however, particularly useful when the multilayer stack is facing the outer environment, whether it is an insulated glazing or laminated glazing, but also optionally a multiple glazing. The glazing may also be enameled. The glazing of the present disclosure can also be annealed, strengthened, toughened, tempered or curved and/or bent.

The tempered glazing can also be used in building wall cladding panel of curtain walling for interior applications. Further it can also be used as a side window, rear window or sunroof for an automobile or other vehicle.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Certain features, that are for clarity, described herein in the context of separate embodiments, may also be provided in combination in a single embodiment. Conversely, various features that are, for brevity, described in the context of a single embodiment, may also be provided separately or in a sub combination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

The description in combination with the figures is provided to assist in understanding the teachings disclosed herein, is provided to assist in describing the teachings, and should not be interpreted as a limitation on the scope or applicability of the teachings. However, other teachings can certainly be used in this application.

As used herein, the terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent that certain details regarding specific materials and processing acts are not described, such details may include conventional approaches, which may be found in reference books and other sources within the manufacturing arts.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

### LIST OF ELEMENTS

10 Glass Substrate
20 First Dielectric Coating M1
21 Dielectric Layer
31, 91 Barrier Layers
50 First Functional Layer F1
80 Second Dielectric Coating M2
81, 82, 83 Dielectric Layers
32, 92 Barrier Layers
100 Second Functional Layer F2
140 Second Dielectric Coating M3
141, 142,143 Dielectric Layers
150 Protective Layer

1. A material comprising a transparent substrate deposited with a stack of thin layers on at least one of its surface successively comprising, starting from the substrate, not more than two metallic functional layers based on silver F1, F2 and three dielectric coatings M1, M2, M3 comprising at least one dielectric layer such that each of the metallic functional layer is sandwiched between two dielectric coatings, wherein:
a. a thickness of second functional layer F2 is greater than a thickness of first functional layer F1, wherein
i. a ratio of the thickness of second functional layer F2 to the thickness of the first functional layer F1 is greater than 1.1 but less than 1.5, inclusive of said value;
b. the three dielectric coatings M1, M2 and M3 each have a thickness T1, T2 and T3, respectively satisfying the following equation: T1, T3<T2, wherein
i. the thickness T1 of the dielectric coating M1 is greater than 20 nm and less than 40 nm, inclusive of said values;
ii. the thickness T2 of the dielectric coating M2 is greater than 60 nm and less than 110 nm, inclusive of said values;
iii. the thickness T3 of the dielectric coating M3 is greater than 15 nm and less than 55 nm, inclusive of said values; and
wherein the material is blue in external reflection (Rₑₓₜ) and has less than 20% reflection internally and externally.

2. The material as claimed in claim 1, wherein the stack of thin layers contain no oxide based layers between the transparent substrate and the first functional layer F1.

3. The material as claimed in claim 1, wherein the thickness of the first functional layer F1 is between 8 nm and 11 nm and the thickness of the second functional layer F2 is between 9 nm and 13 nm.

4. The material as claimed in claim 1, wherein each of the three dielectric coatings M1, M2, M3 comprise at least one dielectric layer based on a material selected from silicon nitride, titanium nitride, nitride or oxynitrides of silicon and aluminum, zinc oxide, tin and zinc oxide, silicon and zirconium nitride, tin oxide, titanium oxide, silicon oxide, aluminum oxide, titanium and tin oxide, alone or in combination.

5. The material as claimed in claim 1, wherein the stack of thin layers further comprises at least one barrier layer deposited above and in contact and/or below and in contact with the metallic functional layers based on silver, a thickness of said at least one barrier layer is between 0.1 nm and 5 nm.

6. The material as claimed in claim 5, wherein the at least one barrier layer is based on NiCr, NiCrOₓ, NiCrNₓ or their combinations thereof.

7. The material as claimed in claim 1, wherein the stack of thin layers optionally comprises at least one protective layer disposed farthest from the surface capable of being in contact with the atmosphere based on titanium zirconium nitride or oxynitride, titanium zirconium oxide, titanium oxide or carbon, alone or in combination.

8. The material as claimed in claim 7, comprising said at least one protective layer, wherein the at least one protective layer has a thickness of less than 5 nm.

9. The material as claimed in claim 1, wherein the stack of thin layers successively starting from the substrate comprises:
a. a first dielectric coating M1 comprising at least one dielectric layer;
b. a first barrier layer;
c. metallic functional layer F1;
d. a second barrier layer;
e. a second dielectric coating M2 comprising at least three dielectric layers;
f. a third barrier layer;
g. metallic functional layer F2;
h. a fourth barrier layer;
i. a third dielectric coating M3 comprising at least three dielectric layers; and
j. optionally at least one protective layer,
k. wherein the material is blue in external reflection (Rₑₓₜ) and has less than 20% reflection internally and externally.

10. The material as claimed in claim 1, wherein the dielectric coatings M2 and M3 comprise at least one layer of oxide disposed above and in contact and/or below and in contact with the barrier layer, a thickness of said layer of oxide is between 2 nm and 10 nm.

11. The material as claimed in claim 1, wherein the material is heat treated at temperatures as high as 600 degrees to 700 degrees for thermal strengthening and/or thermal tempering.

12. The material as claimed in claim 11, wherein the material has a light transmission in the visible spectrum as high as 50% when measured using standard illuminant D65 Obs 2; negative a* and b* values in external reflectance, with b* less than −10, and a solar factor, evaluated according to the standard EN 410 (2011-04) glass side, less than or equal to 30%.

13. A material comprising a transparent substrate deposited with a stack of thin layers on at least one of its surface successively comprising, starting from the substrate:
a. a first dielectric coating M1 comprising at least one dielectric layer having a thickness ranging between 20 nm and 40 nm;
b. a first barrier layer having a thickness ranging between 0.1 nm and 5 nm;
c. a metallic functional layer F1 having a thickness ranging between 8 nm and 11 nm;
d. a second barrier layer having a thickness ranging between 0.1 nm and 5 nm;
e. a second dielectric coating M2 comprising at least three dielectric layers having a thickness ranging between 60 nm and 110 nm;
f. a third barrier layer having a thickness ranging between 0.1 nm and 5 nm;
g. a metallic functional layer F2 having a thickness ranging between 9 nm and 13 nm;
h. a fourth barrier layer having a thickness ranging between 0.1 nm and 5 nm;
i. a third dielectric coating M3 comprising at least three dielectric layers having a thickness ranging between 15 nm and 55 nm, and
optionally at least one protective layer having a thickness ranging not greater than 5 nm, wherein the material is blue in external reflection (Rₑₓₜ) and has less than 20% reflection internally and externally.

14. The material as claimed in claim 13, wherein the stack of thin layers contain no oxide based layers between the transparent substrate and the first functional layer F1.

15. A material comprising a transparent substrate deposited with a stack of thin layers on at least one of its surface successively comprising, starting from the substrate:
a. a first dielectric coating M1 containing a silicon nitride based dielectric layer;
b. a first barrier layer based on NiCr, NiCrOₓ, or NiCrNₓ;
c. a metallic functional layer F1 based on silver;
d. a second barrier layer based on NiCr, NiCrOₓ, or NiCrNₓ;
e. a second dielectric coating M2 containing one silicon nitride based dielectric layer and two other oxide based dielectric layers;
f. a third barrier layer based on NiCr, NiCrOₓ, or NiCrNₓ;
g. a metallic functional layer F2 based on silver;
h. a fourth barrier layer based on NiCr, NiCrOₓ, or NiCrNₓ;
i. a third dielectric coating M3 containing two silicon nitride based dielectric layers and one other oxide based dielectric layer; and
j. optionally at least one protective layer having a thickness ranging not greater than 5 nm,
wherein the material is blue in external reflection (Rₑₓₜ) and has less than 20% reflection internally and externally.

16.-20. (canceled)

21. The material as claimed in claim 12, wherein b* is less than −12.
